(19) United States
(12) Patent Application Publication
(10) Pub. No.: US 2025/0287374 A1
(43) Pub. Date: Sep. 11, 2025

(54) SIMULTANEOUS MULTI-PANEL UPLINK TRANSMISSIONS

(71) Applicant: Apple Inc., Cupertino, CA (US)

(72) Inventors: Seyed Ali Akbar Fakoorian, San Diego, CA (US); Wei Zeng, Saratoga, CA (US); Haitong Sun, Cupertino, CA (US); Yushu Zhang, Beijing (CN); Weidong Yang, San Diego, CA (US); Sigen Ye, Whitehouse Station, NJ (US); Hong He, San Jose, CA (US); Dawei Zhang, Saratoga, CA (US)

(21) Appl. No.: 18/859,043

(22) PCT Filed: Apr. 23, 2022
(86) PCT No.: PCT/CN2022/088642

§ 371 Date: Oct. 22, 2024

(51) Int. Cl. H04W 72/1268; H04W 72/21; H04W 72/232

(52) U.S. Cl. CPC H04W 72/1268; H04W 72/21; H04W 72/232

(57) ABSTRACT

The disclosure relates to a method to be performed by a user equipment (UE). The method includes: receiving a scheduling configuration that configures the UE to perform a plurality of transmissions on a plurality of uplink (UL) resources; selecting, based on a mapping of the plurality of UL resources to antenna panels, a plurality of antenna panels for the plurality of transmissions; and, on a per-panel basis, resolving a time-domain overlap for at least two of the plurality of transmissions such that no more than one transmission is transmitted by each panel at a given time via a same component carrier (CC). The disclosure also relates to another method as well as a UE.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one aspect of the present disclosure, a method to be performed by a user equipment (UE) is disclosed. The method includes: receiving a scheduling configuration that configures the UE to perform a plurality of transmissions on a plurality of uplink (UL) resources; selecting, based on a mapping of the plurality of UL resources to antenna panels, a plurality of antenna panels for the plurality of transmissions; and, on a per-panel basis, resolving a time-domain overlap for at least two of the plurality of transmissions such that no more than one transmission is transmitted by each panel at a given time via a same component carrier (CC).

The previously-described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other implementations may each optionally include one or more of the following features.

In some implementations, resolving the time-domain overlap includes a step in which the UE determines that the at least two transmissions are scheduled on a first antenna panel of the plurality, and a step in which the UE multiplexes the at least two transmissions such that the at least two transmissions are transmitted by the first antenna panel using first UL resources of the plurality.

In some implementations, resolving the time-domain overlap includes a step in which the UE drops at least a portion of one of the at least two transmissions.

In some implementations, resolving the time-domain overlap is based on signaling received from a network serving the UE, and the signaling indicates on the per-panel basis which of the at least two of the plurality of transmissions to transmit. The signaling may be received via a downlink control information (DCI) signal or a radio resource control (RRC) signal and may indicate that a first transmission associated with multiple transmission/reception points (m-TRPs) is prioritized over an overlapping second transmission associated with a single TRP (s-TRP).

In some implementations, resolving the time-domain overlap includes a step in which the UE determines that the at least two transmissions comprise a repeated physical uplink control channel (PUCCH) transmission and a physical uplink shared channel (PUSCH) transmission scheduled during a first time on a first antenna panel of the plurality, and a step in which the UE drops the PUSCH transmission over the first antenna panel during the first time.

In accordance with another aspect of the present disclosure, a method to be performed by a UE is disclosed. The method includes: receiving a scheduling configuration that configures the UE to perform a plurality of transmissions on a plurality of UL resources; selecting, based on a mapping of the plurality of UL resources to antenna panels, a plurality of antenna panels for the plurality of transmissions, wherein the plurality of transmissions comprise two transmissions and the plurality of antenna panels comprise two antenna panels, and wherein each of the two panels corresponds to one of the two transmissions; and performing the two transmissions over the two panels.

The previously-described implementation is also implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other implementations may each optionally include one or more of the following features.

In some implementations, the two transmissions are performed based on whether the two transmissions overlap in a time domain, based on whether the two transmissions overlap in a frequency domain, or based on a RRC parameter.

In some implementations, the two transmissions include two PUSCH transmissions, two PUCCH transmissions, or a PUSCH transmission and a PUCCH transmission.

In some implementations, performing the two transmissions includes a step in which the UE performs one of the two transmissions that is associated with a higher priority.

In some implementations, performing the two transmissions includes a step in which the UE performs one of the two transmissions that starts earlier in time or in frequency and a step in which the UE drops another one of the two transmissions.

In some implementations, performing the two transmissions includes a step in which the UE performs one of the two transmissions that corresponds to a preferred panel.

In some implementations, the two transmissions include two PUSCHs, and performing the two transmissions includes a step in which the UE performs one of the two transmissions that contains uplink control information (UCI).

In some implementations, the two transmissions include two PUCCHs, and performing the two transmissions includes a step in which the UE performs one of the two transmissions that contains UCI with higher priority.

In some implementations, the two transmissions include two PUSCHs, and performing the two transmissions includes a step in which the UE performs one of the two PUSCH transmissions with a greater size of modulation and coding scheme (MCS) or with a greater size of transport block (TB).

In some implementations, the two transmissions include a PUSCH and a PUCCH, and performing the two transmissions is based on signaling received from a network serving the UE. The signaling may indicate which of the two transmissions to transmit, or indicate that a first of the two transmissions associated with m-TRPs is prioritized over a second of the two transmissions associated with an s-TRP.

In accordance with another aspect of the present disclosure, a UE is disclosed. The UE includes: a receiver that receives a scheduling configuration that configures the UE to perform a plurality of transmissions on a plurality of UL resources; and a processor that selects, based on a mapping of the plurality of UL resources to antenna panels, a plurality of antenna panels for the plurality of transmissions, and that resolves, on a per-panel basis, a time-domain overlap for at least two of the plurality of transmissions such that no more than one transmission is transmitted by each panel at a given time via a same CC.

In accordance with another aspect of the present disclosure, a UE is disclosed. The UE includes: a receiver that receives a scheduling configuration that configures the UE to perform a plurality of transmissions on a plurality of UL resources; a processor that selects, based on a mapping of the plurality of UL resources to antenna panels, a plurality of antenna panels for the plurality of transmissions, wherein the plurality of transmissions comprise two transmissions and the plurality of antenna panels comprise two antenna panels, and wherein each of the two panels corresponds to one of the two transmissions; and a transmitter that performs the two transmissions over the two panels.

The details of one or more implementations of these UEs and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, in accordance with some implementations.

FIG. 2 is a flowchart that illustrates an example method for resolving time-domain overlap, in accordance with some implementations.

FIG. 3 illustrates an example for resolving time-domain overlap on a per-panel basis, in accordance with some implementations.

FIG. 4 illustrates another example for resolving time-domain overlap on a per-panel basis, in accordance with some implementations.

FIGS. 5 and 6 each illustrate a flowchart of an example method, in accordance with some implementations.

FIG. 7 illustrates a UE, in accordance with some implementations.

FIG. 8 illustrates an access node, in accordance with some implementations.

### DETAILED DESCRIPTION

In order to increase network coverage, reliability, and data rates, some wireless communication networks support multiple transmission/reception point (multi-TRP or m-TRP) operation. In these networks, one or more base stations may act as or otherwise utilize multiple TRPs to communicate with a UE. To facilitate multi-TRP operation, the TRPs (e.g., the base stations) and the UE can each include multiple antennas or antenna panels, with each panel having multiple antenna elements or beams. A UE that includes multiple panels is referred to as a multi-panel UE.

In general, there are two different operating modes for multi-TRP: single-DCI and multi-DCI. In single-DCI mode, a base station can trigger a UE to transmit one or more PUSCH repetitions (among other uplink [UL] data) towards two TRPs based on one DCI. In multi-DCI mode, a base station can trigger a UE to transmit one or more PUSCH transmissions and/or one or more PUCCH transmissions towards two TRPs based on multiple DCI. In some scenarios, the transmissions may be scheduled such that there is an overlap in time between the different transmissions (which can be arranged for transmission from a single panel or multiple panels of the UE). However, existing networks do not address how a multi-panel UE operates in such scenarios where there is an overlap in time between the UL transmissions. This can lead to communication failures as existing 3GPP specifications do not support simultaneous transmissions of PUCCH and/or PUSCH.

This disclosure describes systems and methods for resolving overlapping UL transmissions over one or more antenna panels of a multi-panel UE. The UL transmissions include those that overlap in the time domain and can occur (i) over the same panel, i.e., on a per-panel basis, or (ii) across multiple panels, i.e., on a cross-panel basis. The UL transmissions also include those transmitted to an s-TRP or (ii) m-TRPs. Among other benefits, the disclosed methods and systems improve the throughput and/or reliability of UL communications.

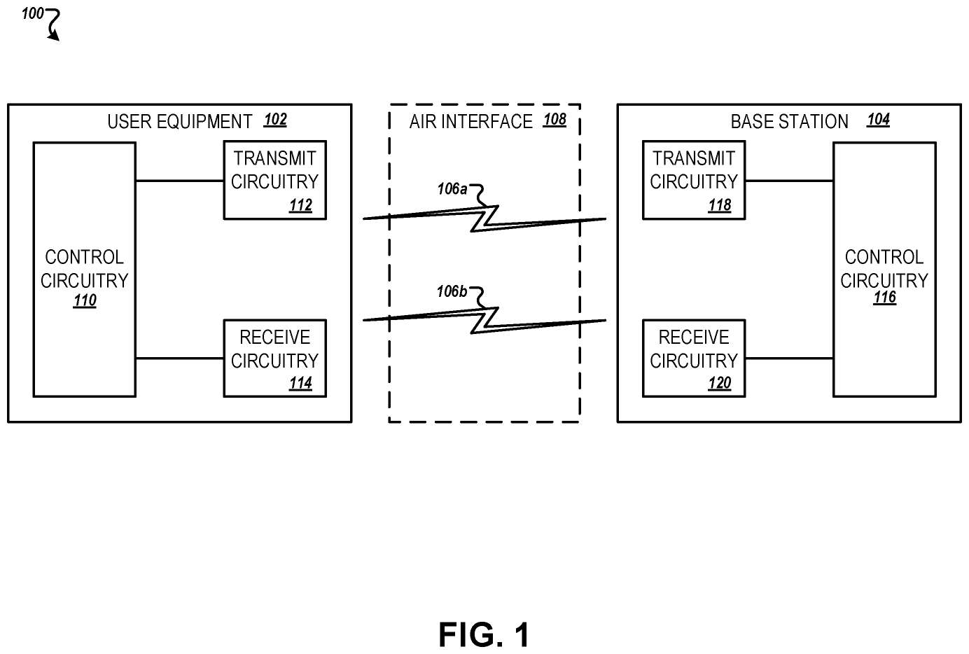

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates LTE and 5G New NR communication standards as defined by the 3GPP technical specifications. For example, the wireless network 100 may be an E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

In line with the discussion above, existing systems do not address simultaneous UL transmissions in multi-panel (e.g., two panels), multi-TRP (e.g., two TRPs) scenarios. The various implementations described herein provide solutions in these scenarios, including cases where: (i) a PUSCH overlaps a PUCCH on the same panel in a multi-panel multi-TRP transmission; (ii) a PUCCH overlaps a PUCCH on the same panel in a multi-panel multi-TRP transmission; and (iii) a PUCCH and a PUSCH are scheduled to be simultaneously transmitted on different panels to different TRPs. In the description below, implementations that resolve overlap on the same panel are considered on a “per-panel” basis, while implementations that resolve overlap on different panels are considered on a “cross-panel” basis.

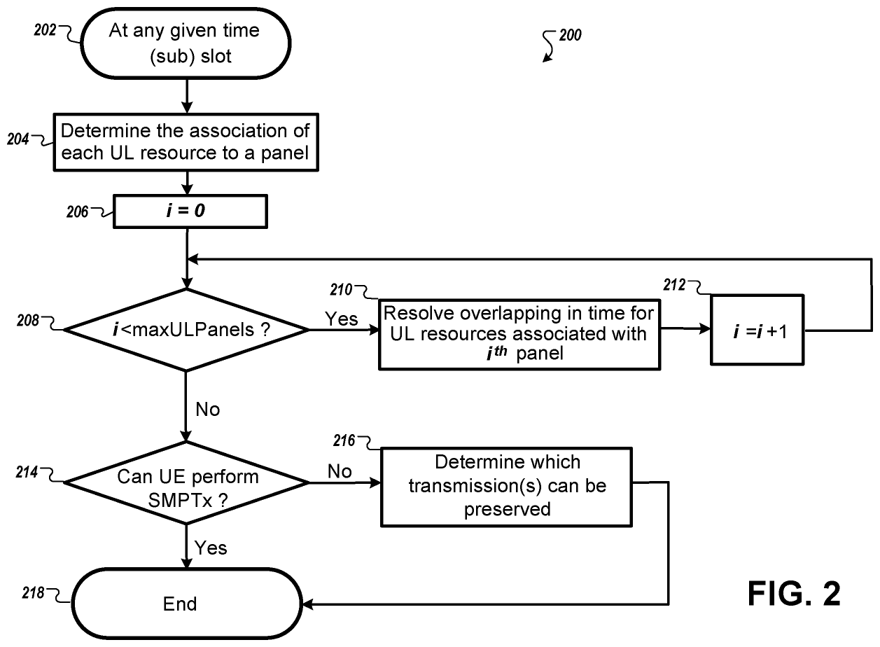

FIG. 2 is a flowchart that illustrates an example workflow 200 for resolving time-domain overlap in multi-panel multi-TRP UL transmissions, according to some implementations. While the following description assumes the method 200 is performed by the UE 102, one of ordinary skill in the art would readily understand that other suitable devices or systems may be used to perform the method 200.

At step 202, the workflow 200 begins for a given time period (e.g., a slot or subslot). In the subsequent steps of the workflow 200, a time-domain overlap of UL transmissions is resolved on a per-panel basis and on a cross-panel basis for the given time period. As described in more detail below, the workflow 200 resolves the time-domain overlap of UL transmissions such that no more than one UL transmission is transmitted by each of the UE 102's panel at a given time via a same CC.

At step 204, the UE 102 determines an association (or mapping) between each UL resource (e.g., resource for a PUCCH and/or a PUSCH transmission) and one or more of the UE 102's N antenna panels, where “N” represents the maximum number of available uplink panels of the UE 102. The association between an UL resource and an antenna panel indicates that the UL resource will be transmitted via that panel. In an example, the association is provided to the UE 102 by a base station (e.g., base station 104) via a scheduling configuration signal. In another example, the UE 102 can select the mapping between UL resources and antenna panels. Specifically, the UE 102 can select which antenna panel is used to transmit which UL resource. In yet another example, the UE 102 is configured to select a fixed antenna panel for a specific channel. For instance, the UE 102 may be configured to always use a fixed panel for a specific channel, or may be configured to use both or all panels for that channel (e.g., PUCCH).

Once the UE 102 determines the mapping between UL resources and the antenna panels for the given time period, the UE 102 moves to steps 206-212. Steps 206-212 represent a loop for resolving a time-domain overlap on a per-panel basis. In one example, an iteration of the loop is performed for each of the N antenna panels of the UE 102. In another example, an iteration of the loop is performed for each of the N antenna panels that is scheduled to transmit an UL transmission during the given time period.

At step 206, the UE 102 initializes a counter, i, that is used to track the number of panels for which conflicts have been resolved. Specifically, the UE 102 sets the counter value to 0. Here, each counter value corresponds to a panel of the UE 102. For example, a value of 0 corresponds to a panel #0 of the UE 102. At step 208, the UE 102 determines whether the current value of the counter is less than a maximum number of panels (i.e., maxULPanels or N panels). If the current counter value is less than the maximum number of panels, the UE 102 moves to step 210 to resolve any overlaps for the UL transmissions scheduled on a panel that corresponds to the current counter value. In other examples, the UE 102 determines whether the current value of the counter is less than a number of panels that are used for UL transmissions in the given time period.

In some implementations, resolving an overlap of UL transmissions on a panel may involve dropping one or more of the UL transmissions or multiplexing one or more of the UL transmissions. For instance, assuming that there are two overlapping UL transmissions, the UE 102 can drop one of the transmissions or multiplex the transmissions together. Note that when a channel is dropped, either the entire transmission for the channel may be dropped or only the overlapped transmission occasion may be dropped. In some implementations, the UE 102 may select between dropping and multiplexing based on several factors, including: (1) the type of UL transmission (e.g., PUCCH vs PUSCH), (2) whether the UL transmission is a repetition, and/or (3) whether there is sufficient time for multiplexing.

As an example, when one of the transmissions is a PUCCH repetition transmission and the other transmission is a PUSCH transmission, the UE 102 preserves the PUCCH transmission and drops the overlapping PUSCH transmission. As another example, if a PUSCH and a PUCCH overlap, the PUCCH may be multiplexed on the PUSCH, provided that a required timeline for multiplexing (per 3GPP specifications) is met. If there are multiple PUSCHs overlapping a PUCCH, one of the PUSCHs can be selected by the UE 102 for multiplexing. In yet another example, if a PUSCH and a PUCCH overlap, the PUSCH may be dropped without UCI multiplexing. Specifically, if a PUSCH transmission without an UL-Shared Channel (UL-SCH) overlaps a PUCCH transmission that includes positive Scheduling Request (SR) information, the UE 102 does not transmit the PUSCH.

In some examples, if a PUSCH and a PUCCH overlap, the PUCCH may be dropped, either partially or completely. The non-dropped portion of the PUCCH, if any, may be multiplexed on the PUSCH. If UCI in a PUCCH transmission is to be multiplexed on an overlapping PUSCH transmission, the UE 102 multiplexes only Hybrid Automatic Repeat Request Acknowledgement (HARQ-ACK) information, if any, from the UCI in the PUSCH transmission. The UE 102 does not transmit the PUCCH if the UE 102 multiplexes aperiodic or semi-persistent Channel State Information (CSI) reports in the PUSCH. Other example multiplexing/dropping rules are described in 3GPP TS 38.213, Section 9.

In some implementations, the UE 102 is configured to receive signaling that indicates, for each panel, which of the overlapping resources is/are preserved and which is/are dropped. The signaling may be implicit (e.g., DCI) or may be explicit such as via an RRC signal. As an example, the signaling may indicate to the UE 102 that an uplink transmission associated with multi-TRP is prioritized over an overlapping uplink transmission associated with single-TRP.

In some implementations, once the time domain overlap is resolved for a panel, the UE 102 moves to step 212. At step 212, the UE 102 increments the counter (i=i+1) and returns to step 208 of determining whether conflicts have been resolved for all panels. The loop is performed until conflicts have been resolved for all panels. Specifically, upon determining “i<maxULPanels” is “No” at step 208, the method 200 moves on to resolving the time-domain overlap on a cross-panel basis, as shown in steps 214 and 216.

At step 214, the UE 102 determines whether it can perform simultaneous multi-panel transmission (SMPTx). That is, the UE 102 determines whether a time-domain overlap exists between multiple uplink channels on a cross-panel basis. In some implementations, this determination may be limited to overlap between transmissions on the same CC, while simultaneous transmissions on different CCs may not be considered an overlap. In addition to this determination, in some implementations, the UE 102 may be configured to receive RRC parameters for enabling/disabling certain types of SMPTx (e.g., simultaneous PUSCHs or simultaneous PUCCHs). In such implementations, the UE 102 performs the SMPTx only when the RRC parameters enable the UE 102 to perform the SMPTx and when the UE 102 determines no cross-panel time-domain overlap exists.

If the UE 102 can and is enabled to perform SMPTx (“Yes” at step 214), then the method 200 ends at step 218 without further processing. Otherwise, if the UE 102 must resolve the cross-panel overlap (“No” at step 214), then the UE 102 decides, at step 216, according to one or more predetermined rules, which uplink transmissions are maintained and which uplink transmissions are dropped. Because the predetermined rules may vary for different types of SMPTx (e.g., two PUSCHs, two PUCCHs, or one PUSCH and one PUCCH), the UE 102 first determines which type of SMPTx to perform and then apply rules correspondingly. The UE 102 may determine which rules to apply either on its own or based on RRC signaling received from a base station.

In some implementations, when the type of SMPTx is multiple PUSCHs on different panels, the UE 102 is configured to first determine whether the overlapping PUSCH transmissions satisfy one of one or more time-domain conditions. Under a first time-domain condition, the UE 102 transmits the two PUSCHs only if they have the same Time Domain Resource Allocations (TDRAs), i.e. they span the same symbols. Under a second time-domain condition, the UE 102 transmits the two PUSCHs only if one of the PUSCHs is within the other one in time domain. Under a third time-domain condition, the UE 102 transmits the two PUSCHs even if the TDRAs of the two PUSCHs only partially overlap.

In some implementations, the UE 102 is configured to further determine whether the overlapping PUSCH transmissions satisfy one or more frequency-domain conditions. Specifically, subject to one or more of the time-domain conditions described above, the UE 102 is configured to further determine whether the overlapping PUSCH transmissions satisfy one of one or more frequency-domain conditions. Under a first frequency-domain condition, the UE 102 transmits the two PUSCHs if they are configured with frequency-division multiplexing (FDM) without overlap in the frequency domain. Under a second frequency-domain condition, the UE 102 transmits the two PUSCHs if they are configured with FDM where partial or full overlap in the frequency domain is allowed. Under a third frequency-domain condition, the UE 102 transmits the two PUSCHs only if they are configured with space division multiplexing (SDM), e.g., multiplexed across multiple panels, with the same Frequency Domain Resource Allocation (FDRA), i.e., full frequency domain overlap.

In some implementations, the UE 102 may select which of the above time-domain conditions and/or frequency-domain conditions to implement based on UE capability signaling received from the base station via, e.g., RRC parameters.

However, if the overlapping PUSCH transmissions do not satisfy the specified time-domain conditions and/or the specified frequency-domain conditions, then the UE 102 is unable to transmit both PUSCHs but needs to drop at least one PUSCH transmission or multiplex one PUSCH transmission over another. To this end, in such scenarios, the UE 102 is configured to select at least one of following options. In a first option, the UE 102 transmits neither of the two PUSCHs. In a second option, the UE 102 transmits the PUSCH that is associated with a higher priority. In a third option, the UE 102 transmits the PUSCH that starts in time (and/or in frequency) earlier and drops the other PUSCH.

In a fourth option, the UE 102 transmits the PUSCH that is associated with a predetermined panel, such as a fixed panel and a preferred panel (e.g., a panel with better beam quality or higher reported Layer One Reference Signal Received Power [L1-RSRP]). In a fifth option, the UE 102 transmits the PUSCH that is associated with UCI. In a sixth option, the UE 102 transmits the PUSCH with a greater size of Modulation and Coding Scheme (MCS) or with a greater transport block (TB) size. The selection of the PUSCH to transmit may be based on a combination of these options. For example, if both PUSCH transmissions contain UCI, then the UE 102 may make the selection based on a different criteria. Such a criteria may be that the UE selects the PUSCH that contains HARQ-ACK, selects the PUSCH that starts earlier, or selects the PUSCH that associates with a preferred panel (e.g., a panel predetermined by the base station or the UE 102).

The rules for SMPTx of multiple PUCCHs are similar to those described above for SMPTx of multiple PUSCHs. For example, under a first time-domain condition, the UE 102 transmits the two PUCCHs only if they have the same TDRAs, i.e. they span the same symbols. Under a second time-domain condition, the UE 102 transmits the two PUCCHs only if one of the PUCCHs is within the other one in time domain. Under a third time-domain condition, the UE 102 transmits the two PUCCHs even if the TDRAs of the two PUCCHs only partially overlap. Likewise, the rules for multiple PUSCH transmissions based on frequency-domain conditions may apply to PUCCH as well.

If the overlapping PUCCH transmissions do not satisfy the specified time-domain conditions and/or the specified frequency-domain conditions, then the UE 102 is unable to transmit both PUCCHs but needs to drop at least one PUCCH transmission or multiplex one PUCCH transmission over another. To this end, the UE 102 may select at least one of a number options that are similar to those described above for SMPTx of PUSCHs. In a first option, the UE 102 transmits neither of the two PUCCHs. In a second option, the UE 102 transmits the PUCCH that is associated with a higher priority. In a third option, the UE 102 transmits the PUCCH that starts in time (and/or in frequency) earlier and drops the other PUCCH. In a fourth option, the UE 102 transmits the PUCCH that is associated with a predetermined panel, such as a fixed panel and a preferred panel (e.g., a panel with better beam quality or higher reported Layer One Reference Signal Received Power [L1-RSRP]). In a fifth option, the UE 102 transmits the PUCCH that contains UCI with a higher priority, where UCI priority is ranked as HARQ-ACK>SR >CSI. In a sixth option, the UE 102 transmits the PUCCH with a greater size of MCS or with a greater size of TB. The selection of the PUCCH to transmit may be based on a combination of these options.

The rules for SMPTx of a PUCCH and a PUSCH are also similar to those described above for SMPTx of multiple PUSCHs. These rules include those under the time-domain conditions and the frequency-domain conditions described above. In the event the time-domain and/or frequency-domain conditions are not satisfied, the UE 102 may select at least one of a number options that are similar to those described above for SMPTx of PUSCHs. In a first option, the UE 102 transmits neither of the PUCCH and the PUSCH. In a second option, the UE 102 transmits the one of the PUCCH and the PUSCH that is associated with a higher priority. In a third option, the UE 102 transmits the one of the PUCCH and the PUSCH that starts in time (and/or in frequency) earlier and drops the other.

In a fourth option, the UE 102 transmits the one of the PUCCH and the PUSCH that is associated with a predetermined panel, such as a fixed panel and a preferred panel. In a fifth option, the UE 102 resolves cross-panel overlap by adopting one or more rules that are applied for resolving per-panel overlap. As an example of the fifth option, when one of the SMPTx is a PUCCH repetition transmission and the other transmission is a non-repeating PUSCH transmission, the UE 102 preserves the PUCCH transmission and drops the overlapping PUSCH transmission. As another example of the fifth option, if a PUSCH and a PUCCH overlap, the PUCCH may be multiplexed on the PUSCH, provided that the required timeline for multiplexing (per 3GPP specifications) is met. In a sixth option, the UE 102 prioritizes the transmission associated with m-TRPs over the transmission associated with s-TRP. The selection between the PUSCH transmission and the PUCCH transmission may also be based on a combination of these options.

Although these scenarios assume the UE 102 is configured for two simultaneous UL transmissions, the previous description may apply to some implementations where the UE 102 is configured for more than two simultaneous transmissions. After the overlap of UL transmissions is resolved, the workflow 200 ends at step 218.

Although the workflow 200 includes processing both on a per-panel basis and on a cross-panel basis, it is possible that some implementations are either on a per-panel basis or on a cross-panel basis. For example, some implementations may resolve time-domain overlap only on a per-panel basis and some implementations may resolve time-domain overlap only on a cross-panel basis. Furthermore, although the workflow 200 described above executes cross-panel processing only after the completion of per-panel processing, it is possible that cross-panel processing is executed earlier than or in parallel with per-panel processing in some implementations.

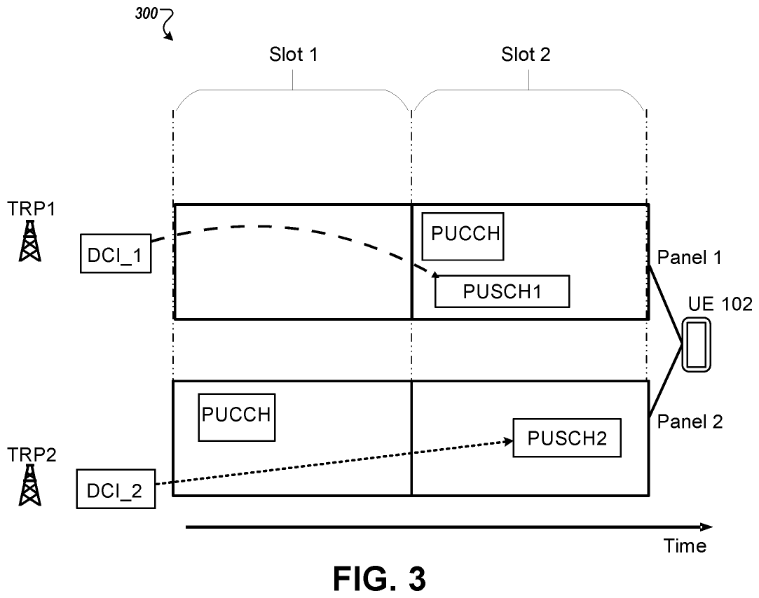

FIG. 3 illustrates an example 300 of resolving overlapping UL transmissions, according to some implementations. In this example, the UE 102 is a multi-panel UE that includes two panels (labeled as Panel 1 and Panel 2). Further, the UE 102 communicates with two TRPs (labeled as TRP 1 and TRP 2). In this example, the UE 102 receives from each TRP a respective DCI that schedules a PUSCH transmission on a respective one of the UE 102's panels. As shown in FIG. 3, the two PUSCH transmissions are scheduled within the same slot (Slot 2) over the two panels of the UE 102. Further, the UE 102 is scheduled to perform a PUCCH transmission in consecutive slots (Slot 1 and Slot 2), where the PUCCH transmission in Slot 2 over Panel 2 is a repetition of the PUCCH transmission in Slot 1 over Panel 1.

As shown in FIG. 3, one of the PUCCH repetitions overlaps PUSCH 1 in Slot 2 on Panel 1. This overlap is on a per-panel basis. To resolve the overlap on Panel 1, the UE 102 is configured to perform the workflow 200 of resolving UL transmission overlaps. In this example, the resolution is to drop PUSCH 1 while preserving the overlapping PUCCH (e.g., based on the rule that if PUCCH with repetition overlaps with a non-repeating PUSCH, the PUSCH is dropped). After dropping PUSCH 1 to resolve the per-panel overlap on Panel 1, no cross-panel overlap exists between Panel 1 and Panel 2.

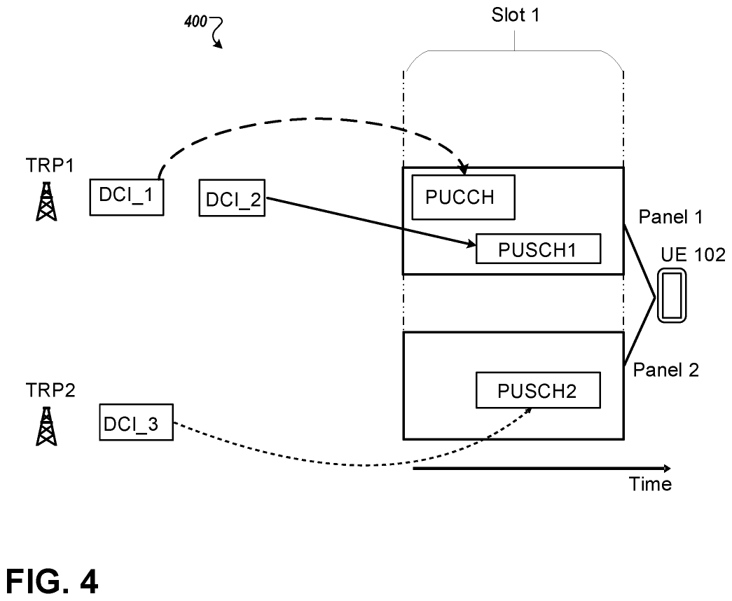

FIG. 4 illustrates an example 400 of resolving overlapping UL transmissions, according to some implementations. In this example, the UE 102 is a multi-panel UE that includes two panels (labeled as Panel 1 and Panel 2). Further, the UE 102 communicates with two TRPs (labeled as TRP 1 and TRP 2). In this example, the UE 102 receives from TRP 1 a DCI (DCI_1) that schedules a PUCCH transmission on Panel 1. The UE 102 also receives from TRP 1 and TRP 2 two DCIs (DCI_2 and DCI_3) that each schedule a PUSCH, PUSCH1 and PUSCH 2, on the two panels of the UE 102. Thus, the PUCCH is a single-TRP transmission while the two PUSCH transmissions are multi-TRP transmissions. All of the transmissions in FIG. 4 are scheduled within the same slot (Slot 1).

As can be seem from FIG. 4, one of the PUSCH transmissions, PUSCH1, overlaps the PUCCH transmission on Panel 1. This overlap is on a per-panel basis. To resolve the overlap on Panel 1, the UE 102 is configured to prioritize the PUSCH transmissions, which are multi-TRP transmissions, over the PUCCH transmission, which is a single-TRP transmission. Thus, for Panel 1, PUSCH 1 is preserved while PUCCH is either partially or completely dropped or multiplexed over PUSCH 1. After resolving the per-panel overlap on Panel 1 between PUCCH and PUSCH 1, there remains to be resolved cross-panel overlap between PUSCH 1 on Panel 1 and PUSCH 2 on Panel 2. To resolve this cross-panel overlap, the UE 102 may implement one or more of the options provided above, subject to the time-domain conditions and/or frequency-domain conditions.

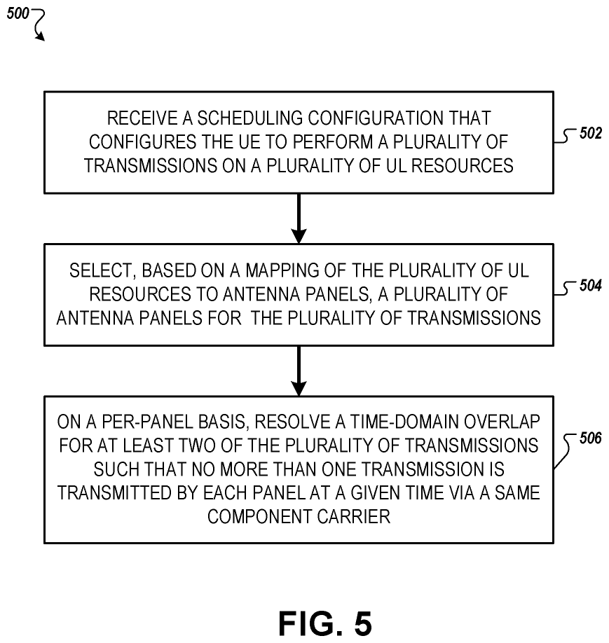

FIG. 5 illustrates a flowchart of an example method 500 performed by a UE, according to some implementations. The method 500 may be performed by the UE 102 of FIG. 1 or any suitable system, environment, software, hardware, or a combination of systems, environments, software, and hardware, as appropriate. Moreover, although steps of the method 500 are numbered in order, implementations of this method are not required to execute the steps in the order they are numbered. It is possible that some implementations execute these steps in different orders or in parallel.

At step 502, the UE receives a scheduling configuration that configures the UE to perform a plurality of transmissions on a plurality of UL resources.

At step 504, the UE selects, based on a mapping of the plurality of UL resources to antenna panels, a plurality of antenna panels for the plurality of transmissions.

At step 506, the UE resolves, on a per-panel basis, a time-domain overlap for at least two of the plurality of transmissions such that no more than one transmission is transmitted by each panel at a given time via a same CC.

In some implementations, resolving the time-domain overlap at step 506 may further a step in which the UE determines that the at least two transmissions are scheduled on a first antenna panel of the plurality, and may further a step in which the UE multiplexes the at least two transmissions such that the at least two transmissions are transmitted by the first antenna panel using first UL resources of the plurality.

In some implementations, resolving the time-domain overlap at step 506 may further a step in which the UE drops at least a portion of one of the at least two transmissions.

In some implementations, resolving the time-domain overlap at step 506 is based on signaling received from a network serving the UE, and the signaling indicates on the per-panel basis which of the at least two of the plurality of transmissions to transmit. The signaling may be a DCI signal or an RRC signal. The signaling may indicate that a first transmission associated with m-TRPs is prioritized over an overlapping second transmission associated with an s-TRP.

In some implementations, resolving the time-domain overlap at step 506 may further a step in which the UE determines that the at least two transmissions include a repeated PUCCH transmission and a PUSCH transmission scheduled during a first time on a first antenna panel of the plurality, and may further a step in which the UE drops the PUSCH transmission over the first antenna panel during the first time.

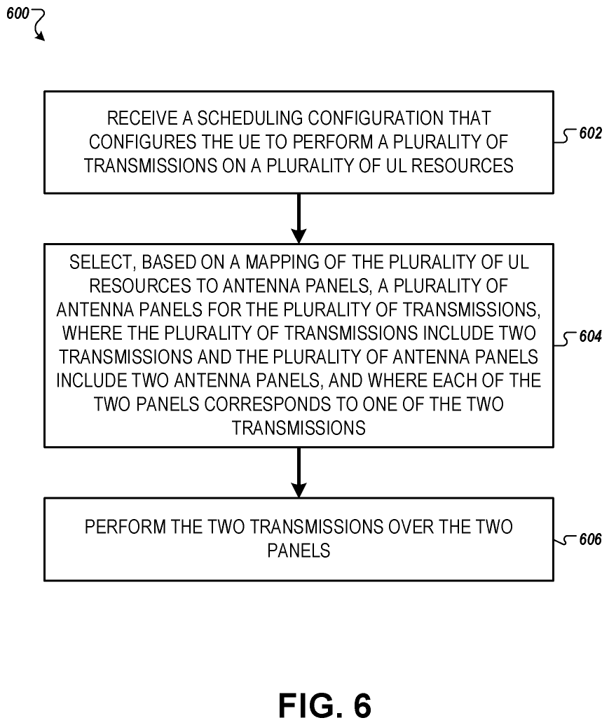

FIG. 6 illustrates a flowchart of an example method 600 performed by a UE, according to some implementations. The method 600 may be performed by the UE 102 of FIG. 1 or any suitable system, environment, software, hardware, or a combination of systems, environments, software, and hardware, as appropriate. Moreover, although steps of the method 500 are numbered in order, implementations of this method are not required to execute the steps in the order they are numbered. It is possible that some implementations execute these steps in different orders or in parallel.

At step 602, the UE receives a scheduling configuration that configures the UE to perform a plurality of transmissions on a plurality of UL resources.

At step 604, the UE selects, based on a mapping of the plurality of UL resources to antenna panels, a plurality of antenna panels for the plurality of transmissions, wherein the plurality of transmissions include two transmissions and the plurality of antenna panels include two antenna panels, and wherein each of the two panels corresponds to one of the two transmissions.

At step 606, the UE performs the two transmissions over the two panels.

In some implementations, performing the two transmissions at step 606 may further a step in which the UE performs the two transmissions based on whether the two transmissions overlap in a time domain, or a step in which the UE performs the two transmissions based on whether the two transmissions overlap in a frequency domain. The two transmissions at step 606 may be performed based on an RRC parameter.

In some implementations, the two transmissions performed at step 606 may include two PUSCH transmissions, two PUCCH transmissions, or a PUSCH transmission and a PUCCH transmission.

In some implementations, performing the two transmissions at step 606 may further a step in which the UE performs one of the two transmissions that is associated with a higher priority.

In some implementations, performing the two transmissions at step 606 may further a step in which the UE performs one of the two transmissions that starts earlier in time or in frequency and a step in which the UE drops the other one of the two transmissions.

In some implementations, performing the two transmissions at step 606 may further a step in which the UE performs one of the two transmissions that corresponds to a preferred panel.

In some implementations, both the two transmissions may be PUCCHs, and performing the two transmissions at step 606 may further a step in which the UE performs one of the two transmissions that contains UCI with higher priority.

In some implementations, both the two transmissions may be PUSCHs, and performing the two transmissions at step 606 may further a step in which the UE performs one of the two transmissions with a greater size of MCS or with a greater size of TB.

In some implementations, the two transmissions may include a PUCCH and a PUSCH, and performing the two transmissions at step 606 may be based on signaling received from a network serving the UE, wherein the signaling indicates which of the two transmissions to transmit. For example, the signaling may indicate that a first of the two transmissions associated with m-TRPs is prioritized over a second of the two transmissions associated with an s-TRP.

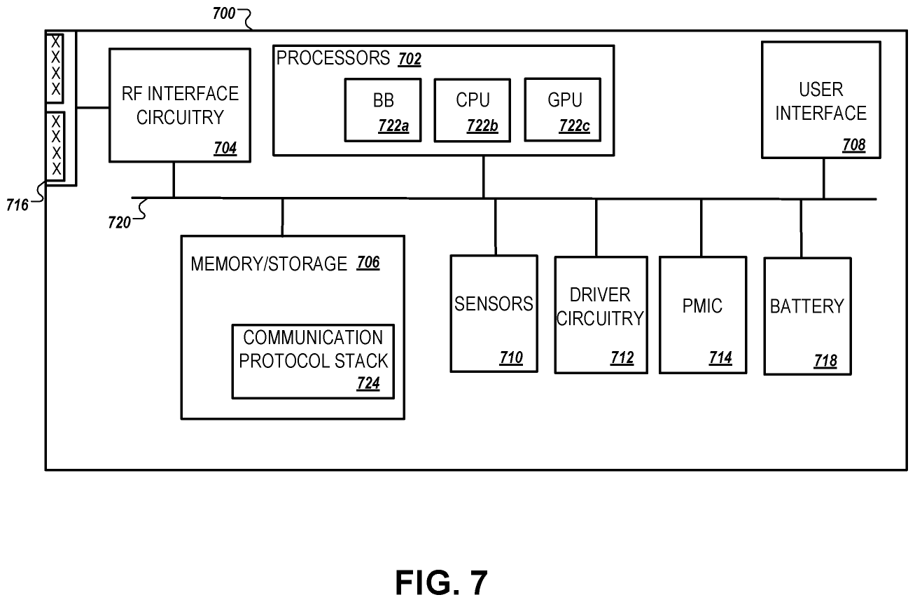

FIG. 7 illustrates a UE 700, according to some implementations. The UE 700 may be similar to and substantially interchangeable with UE 102 of FIG. 1, and may be configured to execute the methods 500 and 600 illustrated in FIGS. 5 and 6.

The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, antenna structure 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716. In various implementations, the RF interface circuitry 704 may be configured to transmit/receive signals in a manner compatible with NR access technologies.

The antenna 716 may include antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensor circuitry 728 and control and allow access to sensor circuitry 728, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location, and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

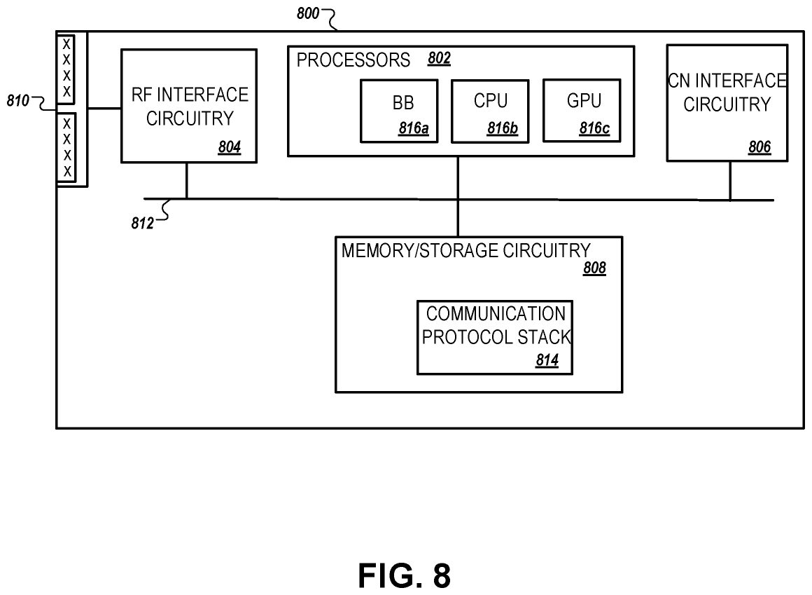

FIG. 8 illustrates an access node 800 (e.g., a base station or gNB), according to some implementations. The access node 800 may be similar to and substantially interchangeable with base station 104. The access node 800 may include processors 802, RF interface circuitry 804, core network (CN) interface circuitry 806, memory/storage circuitry 808, and antenna structure 810.

The components of the access node 800 may be coupled with various other components over one or more interconnects 812. The processors 802, RF interface circuitry 804, memory/storage circuitry 808 (including communication protocol stack 814), antenna structure 810, and interconnects 812 may be similar to like-named elements shown and described with respect to FIG. 7. For example, the processors 802 may include processor circuitry such as, for example, baseband processor circuitry (BB) 816A, central processor unit circuitry (CPU) 816B, and graphics processor unit circuitry (GPU) 816C.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. One or more processors configured to perform operations comprising:
receiving scheduling information that configures a user equipment (UE) to perform a plurality of transmissions on a plurality of uplink (UL) resources;
selecting, based on a mapping of the plurality of UL resources to antenna panels, a plurality of antenna panels for the plurality of transmissions; and
on a per-panel basis, resolving a time-domain overlap for at least two of the plurality of transmissions such that no more than one transmission is transmitted by each panel at a given time via a same component carrier.

2. The one or more processors of claim 1, wherein resolving the time-domain overlap for the at least two transmissions on the per-panel basis comprises:
determining that the at least two transmissions are scheduled on a first antenna panel of the plurality; and
multiplexing the at least two transmissions such that the at least two transmissions are transmitted by the first antenna panel using first UL resources of the plurality.

3. The one or more processors of claim 1, wherein resolving the time-domain overlap for the at least two transmissions on the per-panel basis comprises:
dropping at least a portion of one of the at least two transmissions.

4. The one or more processors method of claim 1, wherein resolving the time-domain overlap for the at least two transmissions is based on signaling received from a network serving the UE, and wherein the signaling indicates on the per-panel basis which of the at least two of the plurality of transmissions to transmit.

5. The one or more processors of claim 4, wherein the signaling is received via a downlink control information (DCI) signal or a radio resource control (RRC) signal.

6. The one or more processors of claim 4, wherein the signaling indicates that a first transmission associated with multiple transmission/reception points (m-TRPs) is prioritized over an overlapping second transmission associated with a single TRP (s-TRP).

7. The one or more processors of claim 1, wherein resolving the time-domain overlap for the at least two transmissions on the per-panel basis comprises:
determining that the at least two transmissions comprise a repeated physical uplink control channel (PUCCH) transmission and a physical uplink shared channel (PUSCH) transmission scheduled during a first time on a first antenna panel of the plurality; and
dropping the PUSCH transmission over the first antenna panel during the first time.

8. One or more processors configured to perform operations comprising:
receiving scheduling information that configures a user equipment (UE) to perform a plurality of transmissions on a plurality of uplink (UL) resources;
selecting, based on a mapping of the plurality of UL resources to antenna panels, a plurality of antenna panels for the plurality of transmissions, wherein the plurality of transmissions comprise two transmissions and the plurality of antenna panels comprise two antenna panels, and wherein each of the two antenna panels corresponds to one of the two transmissions; and
causing transmission of the two transmissions over the two antenna panels.

9. The one or more processors of claim 8, wherein performing the two transmissions comprises:
performing the two transmissions based on whether the two transmissions overlap in a time domain.

10. The one or more processors of claim 8, wherein performing the two transmissions comprises:
performing the two transmissions based on whether the two transmissions overlap in a frequency domain.

11. The one or more processors of claim 8, wherein performing the two transmissions comprises:
performing the two transmissions based on a radio resource control (RRC) parameter.

12. The one or more processors of claim 8, wherein the two transmissions comprise:
two physical uplink shared channel (PUSCH) transmissions;
two physical uplink control channel (PUCCH) transmissions; or
a PUSCH transmission and a PUCCH transmission.

13. The one or more processors of claim 12, wherein performing the two transmissions comprises:
performing one of the two transmissions that is associated with a higher priority.

14. The one or more processors of claim 12, wherein performing the two transmissions comprises:
performing one of the two transmissions that starts earlier in time or in frequency; and
dropping another one of the two transmissions.

15. The one or more processors of claim 12, wherein performing the two transmissions comprises:
performing one of the two transmissions that corresponds to a preferred panel.

16. The one or more processors of claim 12, wherein the two transmissions comprise two PUSCHs, and wherein performing the two transmissions comprises:
performing one of the two transmissions that contains uplink control information (UCI).

17. (canceled)

18. The one or more processors of claim 12, wherein the two transmissions comprise two PUSCH transmissions, and wherein performing the two transmissions comprises:
performing one of the two PUSCH transmissions with a greater size of modulation and coding scheme (MCS) or with a greater size of transport block (TB).

19. (canceled)

20. The one or more processors of claim 8, wherein the two transmissions comprise a PUSCH transmission and a PUCCH transmission, wherein performing the two transmissions is based on signaling received from a network serving the UE, and wherein the signaling indicates which of the two transmissions to transmit.

21. The one or more processors of claim 18, wherein the signaling indicates that a first of the two transmissions associated with multiple transmission/reception points (m-TRPs) is prioritized over a second of the two transmissions associated with a single TRP (s-TRP).

22. A method comprising:
receiving scheduling information that configures a user equipment (UE) to perform a plurality of transmissions on a plurality of uplink (UL) resources
selecting, based on a mapping of the plurality of UL resources to antenna panels, a plurality of antenna panels for the plurality of transmissions; and
resolving, on a per-panel basis, a time-domain overlap for at least two of the plurality of transmissions such that no more than one transmission is transmitted by each panel at a given time via a same component carrier.

23-25. (canceled)
